(19) United States
(12) Patent Application Publication
(10) Pub. No.: US 2007/0059015 A1
(43) Pub. Date: Mar. 15, 2007

(54) Monitoring device for image forming device, control method and control program of monitoring device, and computer-readable storage medium

(75) Inventors: Hirofumi Sakita, Nara (JP); Hirokazu Izumi, Nara (JP); Hideyuki Nishimura, Osaka (JP); Hisaaki Kobayashi, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/495,824

(22) Filed: Jul. 28, 2006

(30) Foreign Application Priority Data
Sep. 12, 2005 (JP) 2005-264474

(51) Int. Cl. G03G 21/02

(52) U.S. Cl. 399/79

(57) ABSTRACT

Provided is a coverage monitor for monitoring a utilization scale of an MFP which forms an image on a sheet with color toner. The coverage monitor comprises: (i) a periodic coverage updating section for generating a periodic coverage which denotes a coverage from a certain time point, which is specified by an administrator of the MFP, to a present time, based on image data expressing the image; and (ii) a display control section for displaying the periodic coverage so that the administrator can visually confirm the coverage. The coverage monitor enables the administrator to easily comprehend the profit rate.

This Nonprovisional application claims priority under 35 U.S.C. § 119(a) on Patent Application No. 2005-264474 filed in Japan on Sep. 12, 2005, the entire contents of which are hereby incorporated by reference.

### FIELD OF THE INVENTION

The present invention relates to a monitoring device which is capable of monitoring utilization scale of an image forming device, and also relates to a control method and a control program of the monitoring device, and a computer readable storage medium.

### BACKGROUND OF THE INVENTION

In a general image forming service using an image forming device such as a photocopier or a printer, the number of photocopied documents or printed sheets is counted by a counter, and the user is charged for the amount found by multiplying the number by an amount per sheet.

In a general image forming service using an image forming device such as a photocopier, or a printer, the number of photocopied documents or printed sheets is counted by a counter, and the user is charged the amount found by multiplying the number by an amount per sheet. Such an image forming service or an image forming device used in an image forming service is disclosed, for example, in Japanese Laid-Open Patent Application Tokukai 2002-99594 (published on Apr. 5, 2002), Japanese Laid-Open Patent Application Tokukai 2002-99836 (published on Apr. 5, 2002), Japanese Laid-Open Patent Application Tokukai 2002-149020 (published on May 22, 2002), Japanese Laid-Open Patent Application Tokukai 1997-160452 (published on Jun. 20, 1997), Japanese Laid-Open Patent Application Tokukai 2003-323092 (published on Nov. 14, 2003), Japanese Laid-Open Patent Application Tokukai 2005-221748 (published on Aug. 18, 2005), U.S. Pat. No. 5,305,199, U.S. Pat. No. 5,604,578, U.S. Pat. No. 6,571,071, U.S. Pat. No. 6,108,099, U.S. Pat. No. 6,023,593, or U.S. Pat. No. 5,383,129.

On the other hand, the profit which the administrator (service provider, service supporting company) of the image forming device gains from the image forming service cannot be estimated only from the number of sheets consumed, because the consumption of toner is also relevant to the cost. More specifically, if the toner consumption is higher than the expected amount for the number of sheets, the profit rate of the administrator of the image forming device decreases.

Therefore, to accurately comprehend the profit rate, the administrator of the image forming device is required to monitor not only the details of sheet consumption (number of printing) but also the details of toner consumption.

### SUMMARY OF THE INVENTION

The present invention is made in view of the foregoing conventional problem, and an object is to provide a monitoring device for an image forming device with a function of allowing the user to easily comprehend a profit scale of an image forming service.

In order to achieve the foregoing objective, a monitoring device of the present invention for monitoring a utilization scale of an image forming device, which forms an image on a sheet with toner, comprises: a periodic consumption scale data generating section for generating periodic consumption scale data which denotes a toner consumption scale from a certain time point, which is specified by an administrator of the image forming device, to a present time, based on image data expressing the image; and a transmission section for transmitting the periodic consumption scale data to the administrator.

This structure allows the administrator of the image forming device to accurately comprehend the degree of toner consumption from an arbitrary time point to the present time. In other words, the monitoring device allows the administrator of the image forming device to comprehend the degree of toner consumption during a specific recent period, enabling the administrator to figure out an accurate profit rate gained by the image forming device in the period.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a functional block diagram showing a structure of a main part of a coverage monitor of a monitoring device according to the first embodiment of the present invention.

FIG. 2 is a vertical cross sectional view showing a MFP to which a coverage monitor of a monitoring device according to the present embodiment is mounted.

FIG. 3 is a functional block diagram showing various functions of an image forming device mounted to the MFP shown in FIG. 2.

FIG. 4 is a functional block diagram showing the entire part of the coverage monitor shown in FIG. 1.

FIG. 5 is a block diagram showing a remote monitoring system including a terminal device and a coverage monitor of the monitoring device according to the present embodiment.

FIG. 6 is a block diagram showing a relationship between (i) an IC chip provided on a toner box, and (ii) a coverage monitor which stores data into the IC chip.

FIG. 7 is a graph showing a relationship between a gradation value and toner consumption.

FIG. 8 is a functional block diagram showing a structure of a main part of a coverage monitor of a monitoring device according to another embodiment of the present invention.

FIG. 9(a) is a drawing of an image displayed in a display device, so as to request to a administrator preparation of a new toner box.

FIG. 9(b) is a drawing of an image displayed in a display device, so as to request to a administrator exchange of toner box.

### DESCRIPTION OF THE EMBODIMENTS

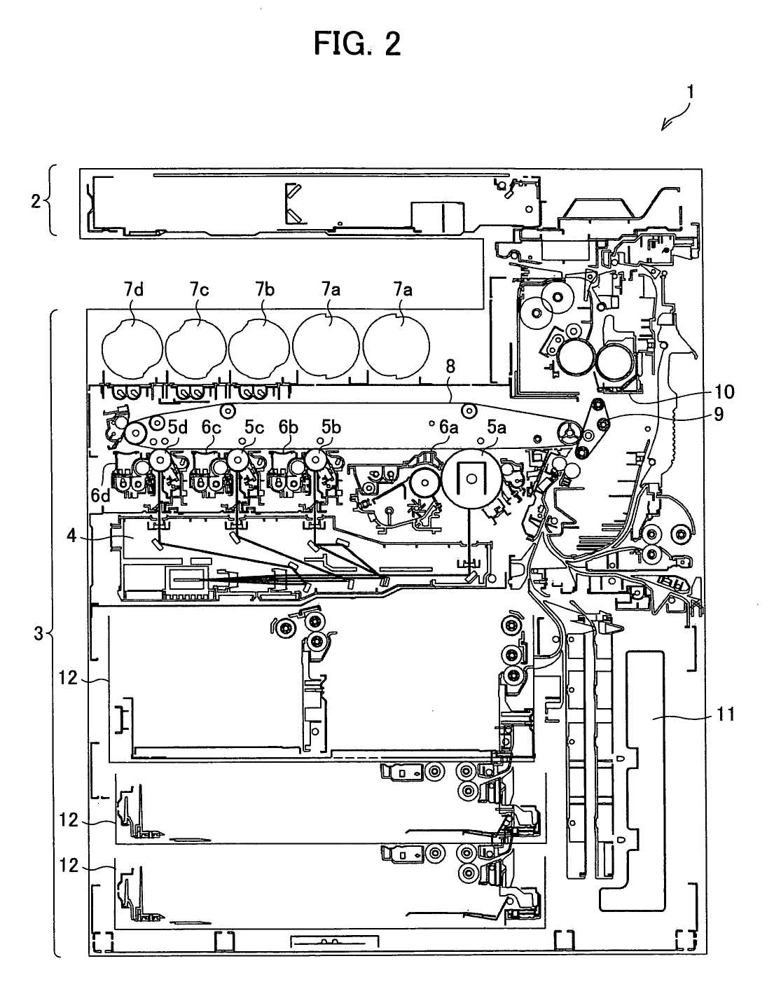

The following explains a monitoring device according to one embodiment of the present invention with reference to Figures. The explanation first deals with an MFP (Multi Function Printer) to which the monitoring device is mounted. FIG. 2 is a vertical cross-sectional view of an MFP.

As shown in FIG. 2, an MFP (image forming device) 1 includes a document scanning device (scanner) 2 for outputting image data scanned from a document by a CCD (charge Coupled Device), and a printer 3 for forming (printing) an image on a paper sheet based on the image data.

The printer 3 is a tandem digital color printer of electrophotographic mode. The printer 3 mainly includes an exposure unit (laser scanner unit) 4, photoconductive drums 5, developing devices 6, toner boxes 7, intermediate transfer belt 8, and a secondary transfer unit 9, a fixing unit 10, a waste toner box 11, and a paper feeding cassette 12.

The image data processed in the MFP corresponds to a multi color image using black (K), cyan (C), magenta (M), and yellow (Y). Therefore, four photoconductive drums 5 (5a, 5b, 5c, 5d), and four development device 6 (6a, 6b, 6c, 6d) are provided to form four types of latent images corresponding to black (K), cyan (C), magenta (M), and yellow (Y), respectively. a, b, c and d correspond to black, cyan, magenta, yellow, respectively.

Further, in the printer 3, the exposure unit 4 exposes the charged photoconductive drums 5 according to the image data inputted from the document scanning device 2 so as to form latent images corresponding to the image data on the surfaces of the photoconductive drums 5. Further, the development device 6 develops the latent images formed on the photoconductive drums 5 respectively with K, C, M, and Y toners (developers). In other words, the toner images of those colors formed on the photoconductive drums 5 are transferred (primary transfer) onto the intermediate transfer belt 8, overlaid with each other. As a result a color toner image, an image of multiple colors, is formed on the intermediate transfer belt 8.

Note that, the development device 6a corresponding to “black” is supplied with black toner from two black toner boxes 7a, the development device 6b corresponding to “cyan” is supplied with cyan toner from a cyan toner box 7b, and the development device 6c corresponding to “magenta” is supplied with magenta toner from a magenta toner box 7c, and the development device 6d corresponding to “yellow” is supplied with yellow toner from an yellow toner box 7d.

Further, the toner images layered on the intermediate transfer belt 8 is transported by rotation of the intermediate transfer belt 8 to a secondary transfer position in which the sheet and the intermediate transfer belt 8 come in contact with each other, and is transferred onto a sheet, which has been transported from the paper-feeding cassette 12, by the secondary transfer unit 9 provided on the secondary transfer position.

Further, the sheet with the multicolor toner image is transported to the fixing unit 10. The multicolor toner image on the sheet is fused/mixed/compressed by a thermal roller and a pressure roller in the fixing unit 10 so as to be thermally fixed into the sheet. The sheet with the fixed multicolor toner image is then outputted to a discharge tray by a transfer roller.

Note that, in the described MFP 1, the image data scanned by the document scanning device 2 is processed by an image processing device (not shown in FIG. 2) provided in the printer 3 before transported to the exposure unit 4. The following minutely explains the image processing device.

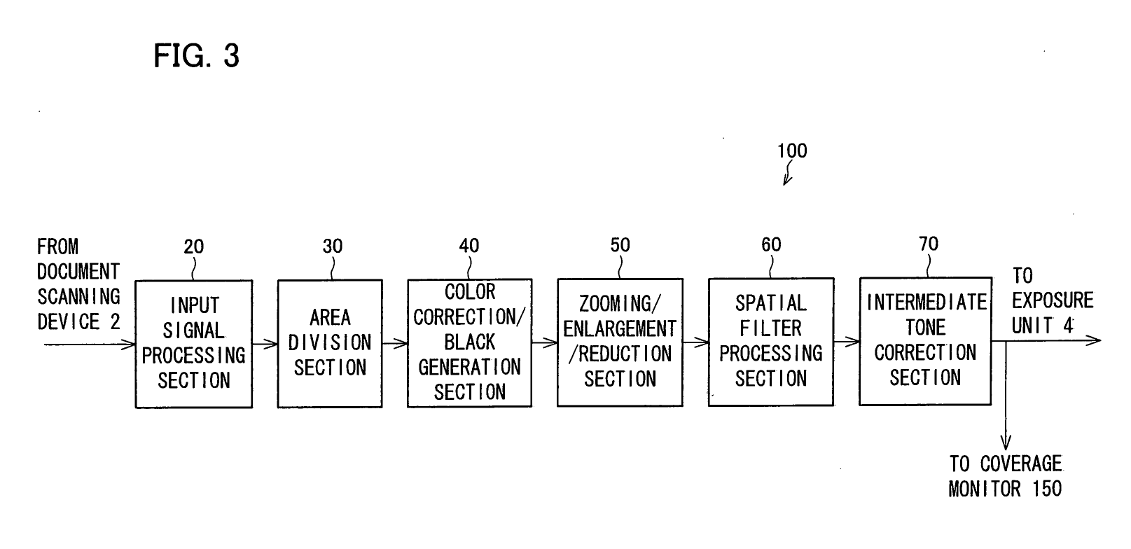

FIG. 3 is a block diagram showing a schematic structure of an image processing device 100. As shown in the figure, the image processing device 100 includes an input signal conditioning section 20, an image area division section 30, a color correction/black generation section 40., a variable power zoom section 50, a spatial filter processing section 60, and an intermediate tone correction section 70. The image data scanned by the document scanning device 2 passes through the input signal processing section 20, the area division section 30, the color correction/black generation section 40, the variable power zoom section 50, the spatial filter processing section 60, and the intermediate tone correction section 70 in this order, before outputted to the exposure unit 4.

The input signal processing section 20 carries out various processings of an input digital image signal of the document scanned by the document scanning device 2, such as pre-processing for the subsequent image processing, gamma correction, density adjustment etc.

The area division section 30 determines the type of image area which the pixels of image data belong to, and generates an area identification signal indicating the determination result. The area identification signal is transmitted to the spatial filter processing section 60 and the intermediate tone correction section 70. Text area, dot area, and continuous gradation area are typical examples of the image area.

Note that, the area identification signal is used to carry out different processings for the plural image areas in the spatial filter processing section 60 and the intermediate tone correction section 70 (eg. a smooth filter processing is performed with respect to a dot area, and an edge enhancement filter processing is performed with respect to the text area).

The color correction/black generation section 40 carries out conversion of the RGB image data transmitted from the area division section 30 into CMYK (cyan, magenta, yellow, black) image data.

The variable power zoom section 50 carries out variable power zoom process of the CMYK image data generated in the color correction/black generation section 40.

The spatial filter processing section 60 selects, from a spatial filter table, a suitable spatial filter for a desired condition, for example, according to the setting of area identification signal or image mode. Then the CMYK image data is subjected to spatial filter processing.

The intermediate tone correction section 70 corrects an intermediate tone gamma characteristic of the image data having been through the spatial filter processing. Then, the image data having been through the intermediate tone correction in the intermediate tone correction section 70 is transmitted to the exposure unit 4 shown in FIG. 2 and a coverage monitor 150 (described below).

The following explains the coverage monitor 150. The coverage monitor 150 is mounted to the MFP 1, and carries out, every time the MFP 1 carries out printing job, calculation of total coverage, periodical coverage, and sheet-based coverage with respect to the image data transmitted from the intermediate tone correction section 70. Through the calculation the coverage monitor 150 updates these coverages and stores the modified values.

The coverage is a ratio (%) of the area of the dots with respect to the area of the sheet on which the dots are formed. The coverage indicates a toner consumption extent of the MFP 1.

The total coverage expresses a coverage value for the total printing processing of the MFP 1, which is counted from the time where a new device is operated for the first time (at the time the device is delivered) to the present time. The total coverage (%) is expressed as follows.

Total coverage=the total dot area formed through the whole printing operation/the total area of sheet used in the whole printing operation

The total dot area and the total area of sheet are both counted from the time a new device is started to the present time.

The periodical coverage expresses a coverage value for the total printing processing, counted from a certain time point to the present time. The periodical coverage (%) is expressed as follows.

Periodical coverage=the total dot area formed through the whole printing operation from a certain time point determined by the user to the present time/the total area of sheet used in the whole printing operation from a certain time point to the present time.

The total dot area and the total area of sheet are both counted from a certain time point determined by the user to the present time.

The sheet-based coverage expresses a coverage value for each sheet. The sheet-based coverage (%) is expressed as follows.

Sheet-based coverage=the total dot area formed on a single sheet/the total area of the sheet

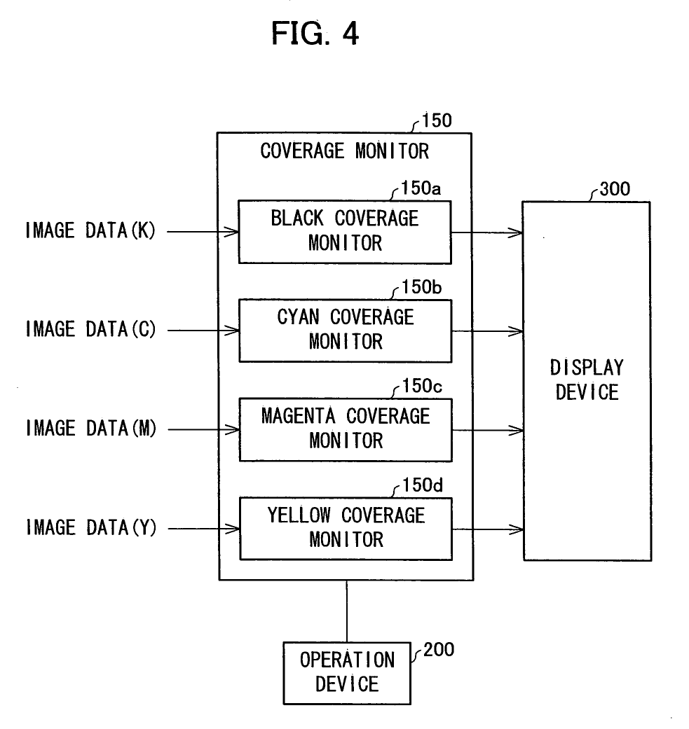

As shown in FIG. 4, the coverage monitor 150 includes a black coverage monitor 150a, a cyan coverage monitor 150b, a magenta coverage monitor 150c, and a yellow coverage monitor 150d.

The black coverage monitor 150a calculates the respective coverage values (total coverage, periodical coverage, sheet-based coverage) with respect to black toner based on the black image data, and stores the calculation result. The cyan coverage monitor 150b calculates the respective coverage values with respect to cyan toner based on the cyan image data, and stores the calculation result. The magenta coverage monitor 150c calculates the respective coverage values with respect to magenta toner based on the magenta image data, and stores the calculation result. The yellow coverage monitor 150d calculates the respective coverage values with respect to yellow toner based on the yellow image data, and stores the calculation result.

The coverage monitor 150 is connected to the operation device 200 and the display device 300. The administrator of the MFP 1 is allowed to input various commands from the operation device 200 to the coverage monitor 150. Further, the respective calculation results stored in the black coverage monitor 150a, the cyan coverage monitor 150b, the magenta coverage monitor 150c and the yellow coverage monitor 150d are displayed in the display device 300.

Next, the following explains the black coverage monitor 150a in detail. Note that, the black coverage monitor 150a, the cyan coverage monitor 150b, the magenta coverage monitor 150c and the yellow coverage monitor 150d are different in color component of input image data and in color component of toner of the coverage to be calculated and stored, but are identical in operation process. Therefore, the separate explanations for the cyan coverage monitor 150b, the magenta coverage monitor 150c and the yellow coverage monitor 150d are omitted.

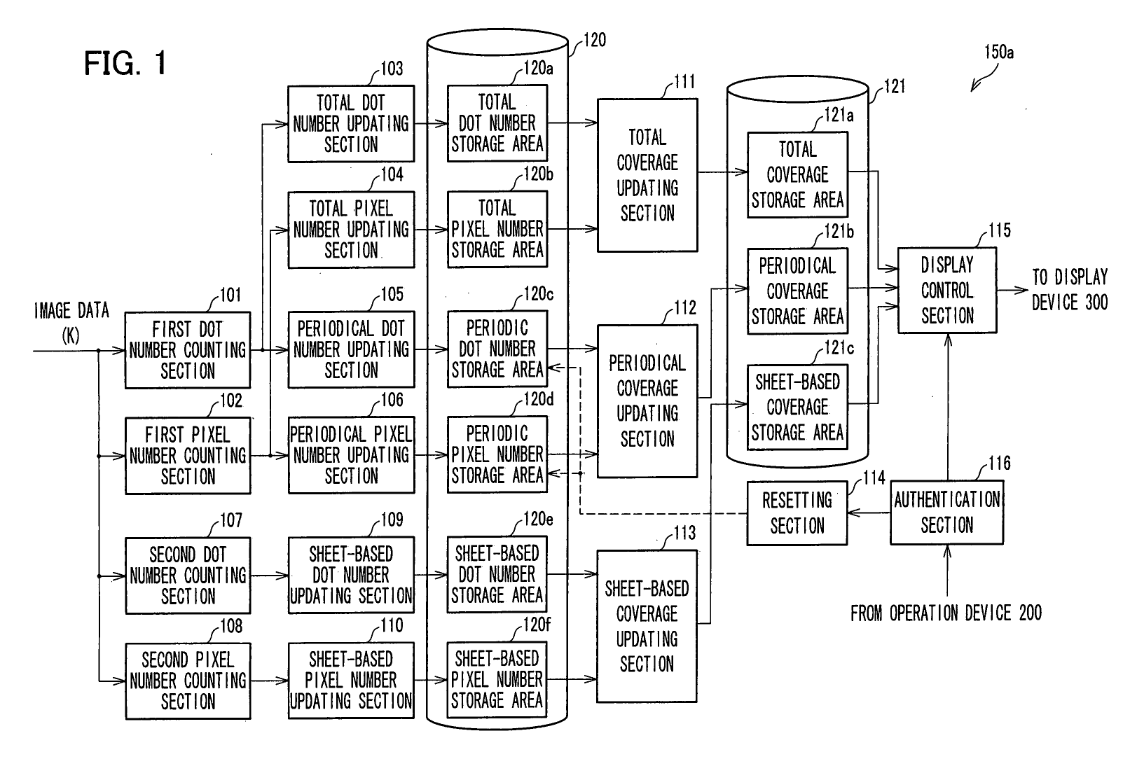

As shown in FIG. 1, the black coverage monitor 150a has a first dot number counting section 101, a first pixel number counting section 102, a total dot number updating section 103, a total pixel number updating section 104, a periodical dot number updating section 105, a periodical pixel number updating section 106, a second dot number counting section 107, a second pixel number counting section 108, a sheet-based dot number updating section 109, a sheet-based pixel number updating section 110, a total coverage updating section 111, a periodical coverage updating section 112, a sheet-based coverage updating section 113, a resetting section 114, a display control section 115 and an authentication section 116.

The black coverage monitor 150a further includes a first storage device 120, and a second storage device 121. The first storage device 120 includes a total dot number storage area 120a, total pixel number storage area 120b, a periodic dot number storage area 120c, a periodic pixel number storage area 120d, a sheet-based dot number storage area 120e, a sheet-based pixel number storage area 120f. The second storage device 121 includes a total coverage storage area 121a, a periodical coverage storage area 121b, and a sheet-based coverage storage area 121c.

The authentication section 116 carries out authentication of the administrator by comparing an administrator ID inputted from the operation device 200 and the IDs stored therein. More specifically, the authentication section 116 carries out comparison between the inputted administrator ID and the IDs stored therein, and if they are matched, determines that the administrator is a proper administrator. On the other hand, if they are not matched, the authentication section 116 determines that the administrator is not a proper administrator.

The authentication section 116 also accepts the various commands from the operation device 200 as long as the commands are inputted by a proper administrator, and transmits the commands to the resetting section 114 or the display control section 115. The authentication section 116 invalidates the commands inputted by an improper administrator through the operation device 200.

The first dot number counting section 101 is a block for counting the dot number of black toner in the whole printed image resulting from the printing job, based on the image data supplied from the intermediate tone correction section 70. The first dot number counting section 101 carries out this counting every time the printing job is carried out in the MFP. In other words, the first dot number counting section 101 counts the number of pixels which form dots (ON-pixels) in the image data.

Note that, the “dots” designates a smallest unit of a toner image formed on a sheet (a smallest unit of a toner portion in the final output data, i.e., a smallest unit of ON-state pixels).

The first pixel number counting section 102 is a block for counting the number of pixels of the whole printed image resulting from the printing job, based on the image data supplied from the intermediate tone correction section 70. The first pixel number counting section 102 carries out this counting every time the printing job is carried out in the MFP. In other words, the first pixel number counting section 102 counts the number of pixels which form dots (ON pixels) and the number of pixels which do not form dots (OFF pixels) in the image data.

Note that, the “pixels” designates a smallest unit of an image formed on a sheet (a smallest unit (ON pixels) of a toner portion and a smallest unit (OFF pixels) of a non-toner portion in the final output data).

The total dot number updating section 103 is a block for updating the dot number stored in the total dot number storage area 120a as the first dot number counting section 101 figures out a new dot number. More specifically, the total dot number updating section 103 adds a new dot number figured out by the first dot number counting section 101 to the existing dot number previously stored in the total dot number storage area 120a. Then the total dot number updating section 103 saves the new dot number into the total dot number storage area 120a (so that the dot number is updated).

In a MFP 1 in initial state, the dot number in the total dot number storage area 120a shows 0. Then the number is updated by the total dot number updating section 103 every time the printing job is carried out in the MFP 1.

In this way, the total dot number storage area 120a constantly saves the total dot number, i.e., the total dot number of black toner, which is counted by the first dot number counting section 101 from the time where a new device is operated for the first time (at the time the device is delivered) to the present time.

The total pixel number updating section 104 is a block for updating the pixel number stored in the total pixel number storage area 120b as the first pixel number counting section 102 figures out a new dot number. More specifically, the total pixel number updating section 104 adds a new pixel number figured out by the first pixel number counting section 102 to the existing pixel number previously stored in the total pixel number storage area 120b. Then the total pixel number updating section 104 saves the new dot number into the total pixel number storage area 120b (so that the pixel number is updated).

In a MFP 1 in initial state, the pixel number in the total pixel number storage area 120b shows 0. Then the number is updated by the total pixel number updating section 104 every time the printing job is carried out in the MFP 1.

In this way, the total pixel number storage area 120b constantly saves the total pixel number, i.e., the total pixel number counted by the first pixel number counting section 102 from the time where a new device is operated for the first time (at the time the device is delivered) to the present time.

The total coverage updating section 111 divides the dot number stored in the total dot number storage area 120a by the pixel number stored in the total pixel number storage area 120b, every time the value in the total dot number storage area 120a or the value in the total pixel number storage area 120b is updated. The resulting value is stored in the total coverage storage area 121a. The value is updated as the total coverage updating section 111 carries out another division.

Here, the pixel number stored in the total pixel number storage area 120b is the total pixel number (the gross of the number of pixels which form dots (ON pixels) and the number of pixels which do not form dots (OFF pixels) counted by the first pixel number counting section 102 from the time where a new MFP 1 is operated for the first time to the present time. The total dot number stored in the total dot number storage area 120a is the total dot number (the total dot number of black toner) counted by the first dot number counting section 101 from the time where a new MFP 1 is operated for the first time to the present time.

Therefore, the value calculated by the total coverage updating section 111 denotes a ratio of the total area of the black dot section to the total area of sheet throughout the whole printing operation carried out in the MFP 1 since the MFP 1 is operated for the first time (at the time the device is delivered) to the present time. Accordingly, the value stored in the total coverage storage area 121a is a total coverage of black toner.

The periodical dot number updating section 105 is a block for updating the dot number stored in the periodical dot number storage area 120c every time the first dot number counting section 101 carries out counting of the dot number. More specifically, the periodical dot number updating section 105 adds a new dot number figured out by the first dot number counting section 101 to the existing dot number previously stored in the total dot number storage area 120a. Then the periodical dot number updating section 105 saves the new dot number into the periodical dot number storage area 120c (so that the dot number is updated).

When the administrator of the MFP 1 inputs a reset command through the operation device 200, the reset command is transmitted to the resetting section 114 via the authentication section 116. Receiving the reset command, the resetting section 114 changes respective values stored in the periodical dot number storage area 120c and the periodical pixel number storage area 120d into 0 (the resetting section 14 resets those values).

In other words, the total dot number (periodical dot number) stored in the periodical dot number storage area 120c is a total pixel number counted by the first dot number counting section 101 from the previous resetting operation (that is, the time specified by the administrator by way of inputting reset command) to the present time.

The periodical pixel number updating section 106 is a block for updating the pixel number stored in the periodical pixel number storage area 120d every time the first pixel number counting section 102 carries out counting of the pixel number. More specifically, the periodical pixel number updating section 106 adds a new pixel number figured out by the first pixel number counting section 102 to the existing pixel number previously stored in the periodical pixel number storage area 120d. Then the periodical pixel number updating section 106 saves the new pixel number into the periodical pixel number storage area 120d (so that the pixel number is updated).

Further, as described above, the periodical pixel number storage area 120d is arranged to reset the stored value (the value becomes 0) in response to the reset command inputted by the user. That is, the total pixel number stored in the periodical pixel number storage area 120d is a total pixel number counted by the first pixel number counting section 102 from the previous resetting operation (that is, the time specified by the administrator by way of inputting reset command) to the present time.

The periodical coverage updating section 112 divides the dot number stored in the periodical dot number storage area 120c by the pixel number stored in the periodical pixel number storage area 120d, every time the value in the periodical dot number storage area 120c or the value in the periodical pixel number storage area 120d is updated. The resulting value is stored in the periodical coverage storage area 121b. The value is updated as the periodical coverage updating section 112 carries out another division.

Here, the pixel number stored in the periodical pixel number storage area 120d is the periodical pixel number (the gross of the number of pixels which form dots and the number of pixels which do not form dots) which is counted by the first pixel number counting section 102 from a certain time point specified by the administrator to the present time. The periodical dot number stored in the periodical dot number storage area 120c is the total periodical dot number (the total periodical dot number of black toner) counted by the first dot number counting section 101 from a certain time point specified by the administrator to the present time.

Therefore, the value found by dividing the total dot number by the total pixel number denotes a ratio of the total area of the black dot section to the total area of sheet throughout the whole printing operation from a certain time point specified by the administrator to the present time. Accordingly, the value stored in the periodical coverage storage area 120b is a periodical coverage.

The second dot number counting section 107 is a block for counting the dot number of black toner in the final printed sheet in the printing job. The counting is performed based on the image data supplied from the intermediate tone correction section 70 every time the printing job is carried out in the MFP 1.

The second pixel counting section 108 is a block for counting the pixel number of the image of the final printed sheet in the printing job. The counting is performed based on the image data supplied from the intermediate tone correction section 70 every time the printing job is carried out in the MFP 1.

The sheet-based dot number updating section 109 is a block for updating the dot number stored in the sheet-based dot number storage area 120e. The updating is performed for each time the second dot number counting section 107 carries out counting of the dot number. More specifically, each time the second dot number counting section 107 carries out counting of the dot number, the sheet-based dot number updating section 109 deletes the dot number stored in the sheet-based dot number storage area 120e, and stores the new value given by the second dot number counting section 107 to the sheet-based dot number storage area 120e.

Therefore, the sheet-based dot number storage area 120e always has a dot number of black toner of the image of the final printed sheet in the latest printing job.

The sheet-based pixel number updating section 110 is a block for updating the pixel number stored in the sheet-based pixel number storage area 120f. The updating is performed for each time the second pixel counting section 108 carries out counting of the pixel number. More specifically, each time the second pixel counting section 108 carries out counting of the pixel number, the sheet-based pixel number updating section 110 deletes the pixel number stored in the sheet-based pixel number storage area 120f, and stores the new value given by the second pixel counting section 108 to the sheet-based pixel number storage area 120f.

Therefore, the sheet-based pixel number storage area 120f always has a number of pixels (number of dots for each sheet) of the image of the final printed sheet in the latest printing job.

The sheet-based coverage updating section 113 divides the dot number stored in the sheet-based dot number storage area 120e by the pixel number stored in the sheet-based pixel number storage area 120f, every time the value in the sheet-based dot number storage area 120e or the value in the sheet-based pixel number storage area 120f is updated. The resulting value is stored in the sheet-based coverage storage area 121c. The value is updated as the sheet-based coverage updating section 113 carries out another division.

Here, the pixel number stored in the sheet-based pixel number storage area 120f is the total pixel number (the gross of the number of pixels which form dots and the number of pixels which do not form dots) of the image of the final printed sheet in the latest printing job. The total dot number stored in the sheet-based dot number storage area 120e is the total dot number (the total dot number of black toner) of the image of the final printed sheet in the latest printing job.

Therefore, the value calculated by the sheet-based coverage updating section 113 denotes a ratio of the total area of the black dot section to the total area of a sheet, for the image of the final printed sheet in the latest printing job. Accordingly, the value stored in the sheet-based coverage storage area 121c is the sheet-based coverage.

The display control section 115 is a block for displaying the respective values stored in the total coverage storage area 121a, the periodical coverage storage area 121b and the sheet-based coverage storage area 121c. The values are displayed in the display section 300 in response to a display command which is supplied from the operation device 200 via the authentication section 116.

That is, the administrator of the MFP 1 may cause the display device 300 to display the total coverage, the periodical coverage, and the sheet-based coverage by the input of the display command through the operation device 200. This allows the administrator to visually confirm the values.

As described, the coverage monitor 150 is a monitoring device for monitoring a utilization scale of the MFP 1 which forms an image on a sheet with toner, the monitoring device comprising: a periodical coverage updating section (periodic consumption scale data generating section) 112 for generating a periodic coverage (periodic consumption scale data) which denotes a scale of toner consumption from a certain time point specified by the administrator to a present time, based on image data; and a display control section (transmission section) 115 for informing the administrator of the periodic coverage with the display of the value of coverage.

With this structure, the coverage monitor 150 allows the administrator of the MFP 1 to accurately comprehend the degree of toner consumption from an arbitrary time point to the present time. In other words, the coverage monitor 150 allows the administrator of the MFP 1 to comprehend the degree of toner consumption during a specific recent period, enabling the administrator to figure out an accurate profit rate of the MFP 1 in the period.

The coverage monitor 150 further comprises a total coverage updating section (total consumption scale data generating section) 111 for generating total consumption coverage which denotes a scale of total toner consumption of the MFP 1, based on the image data. The display control section 115 displays the total coverage, allowing the administrator to visually confirm the total coverage.

Therefore, the administrator can comprehend the respective total toner consumptions of all MFP 1 under the administrator's charge, which means that the administrator can comprehend the degree of toner consumption in the whole market. Therefore the stock management of toner, planning of manufacturing toner etc. become easy (e.g. the administrator more easily estimates the required number of toner bottles).

Further, the administrator may refer to the information of total toner consumption amount in developing a new MFP. The information of total toner consumption is useful to create an MFP meeting real demands in the market.

The coverage monitor 150 further comprises a sheet-based coverage updating section (sheet-based consumption scale data generating section) 113 for generating sheet-based coverage for showing a scale of toner consumption in the case of carrying out image forming with respect to a single sheet (or a predetermined number of sheets), based on the image data. The control section 115 displays the sheet-based coverage in the display device 300, allowing the administrator to visually confirm the coverage.

Therefore, in addition to the total toner consumption and the toner consumption in a certain period, the administrator can also comprehend toner consumption per sheet (or for a predetermined number of sheets). The administrator can thus easily estimate a toner amount required for a single sheet.

Further, the display control section 115 displays the sheet-based coverage only in response to a display command from a proper administrator, that is, an administrator approved by the authentication section 116 (in other words, an administrator who has inputted an administrator ID as a proof). On this account, only a proper administrator is notified of the total coverage, the periodic coverage, and the sheet-based coverage, ensuring confidentiality of the coverages.

Further, though the foregoing example describes a case where the administrator of the coverage monitor 150 is notified of the total coverage, the periodic coverage, and the sheet-based coverage with the display in the display device 300, the notification may be carried out in other way. For example, the coverage monitor of FIG. 1 may include a printer control section for controlling the operation of the printer 3. In this case, the printer control section (transmission section) 3 causes the printer 3 to carry out printing of an image of the coverages, which are respectively stored in the total coverage storage area 121a, the periodical coverage storage area 121b, and the sheet-based coverage storage area 121c, on a sheet in response to a printing command transmitted from the operation device 200 via an authentication section 116. In this structure, the administrator is notified of the total coverage, the periodic coverage, and the sheet-based coverage by printing of the coverages.

Another example of notification of the total coverage, the periodic coverage, and the sheet-based coverage to the administrator is a remote monitoring system (eg. RIC), which can be realized by connecting the coverage monitor 150 in the MFP 1 to a terminal device of the administrator via a public line. In this case, the respective coverages stored in the coverage monitor 150 are transmitted to the terminal device of the administrator via a public line. The following explains an example of this system.

An example of the system is shown in FIG. 5. A black toner coverage monitor 150a includes an e-mail creating section 160 and a transmission section 161. The e-mail creating section reads out respective values in the total coverage storage area 121a, a periodical coverage storage area 121b, and a sheet-based coverage storage area 121c at certain intervals (eg. once a week, once a month), and creates an e-mail including those values.

The transmission section 161 serves to carry out data transmission to the terminal device 400 via the Internet NT. Receiving an e-mail created by the e-mail creating section 160, the transmission section 161 transmits the e-mail to the terminal device 400. This structure allows the administrator to monitor the total coverage, the periodic coverage, and the sheet-based coverage of the MFP 1 with his own terminal device.

Further, the foregoing coverage monitor 150 displays the total coverage, the periodic coverage, and the sheet-based coverage to the administrator as data of a toner consumption scale, but other types of data may be used as data to indicate toner consumption.

For example, in response to the display command transmitted from the operation device 200, the display control section 115 may display (i) a total dot number, (ii) a periodical dot number, and (iii) a sheet-based dot number, which are stored in the total dot number storage area 120a, a periodical dot number storage area 120c, and a sheet-based dot number storage area 121e, respectively. These dot numbers are also useful for the administrator to comprehend toner consumption in the MFP 1. Specifically, the total dot number indicates the total toner consumption in the MFP 1, the periodical dot number indicates toner consumption from a certain time point specified by the administrator to the present time, and the sheet-based dot number indicates toner consumption per sheet.

Further, the dot number may be stored in an IC chip (storage device) capable of writing/storing data. In this case, the IC chip may be mounted to the detachable toner box 7 in the MFP 1. For example, the counting of dot number is automatically started from the time where the toner box 7 is mounted to the MFP 1, updated by every another operation. The following explains this structure in detail.

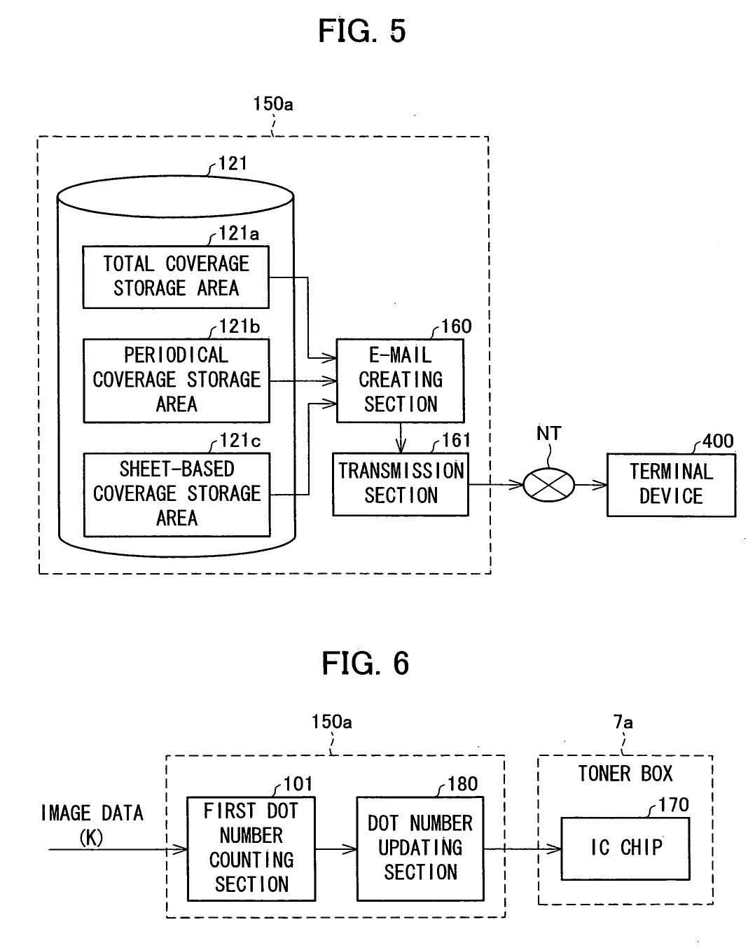

As shown in FIG. 6, the black toner box 7a includes an IC (Integrated Circuit) chip 170. Here, at the time the IC chip 170 is just mounted to the black toner box 7a, the dot number counter is in an initial state, which is 0. The black toner coverage monitor 150a includes a dot number updating section (dot count value writing section) 180 for updating the dot number stored in the IC chip 170. With this dot number updating section 180, the dot number stored in the IC chip 170 is updated every time the first dot number counting section 101 carries out counting. More specifically, the total dot number updating section 103 adds a new dot number figured out by the first dot number counting section 101 to the existing dot number previously stored in the IC chip 170. Then the dot number updating section 180 saves the new dot number into the IC chip 170 (so that the dot number is updated).

With this function, the total dot number counted by the first dot number counting section 101 from the time where the toner box 7 is mounted to the MFP 1 to the present time is stored in the IC chip 170. In other words, the total number of the black toner dots formed throughout the all previous printing jobs is stored in the IC chip 170. This allows the administrator to compare the dot number stored in the IC chip 170 of the toner box 7a and the actual toner content of the cartridge after the administrator collects an empty toner box 7 for replacement. With this comparison the administrator can check reliability of the dot number as a factor of actual toner consumption amount.

Further, instead of the total coverage, the periodic coverage, the sheet-based coverage, the total dot number, the periodical dot number, and the sheet-based dot number, any alternative data may be used for indication of toner consumption. For example, these data items may be replaced with a data group of small domain count: a total area data, periodical area data, and sheet-based area data, which are each calculated as a ratio (%) of the area of dots formed in a predetermined size of portion in a sheet to the whole area of the region. These data items may also be transmitted to the administrator in the above methods.

These three area data items are expressed as follows.

Total area data (%)=a total dot area formed in the certain size of portion of sheet from the time where a new device is operated for the first time to the present time/the total area of the certain sized portion in the all sheet having been subjected to printing from the time where a new device is operated for the first time to the present time

Periodical area data (%)=the total dot area formed in the certain sized portion from the time specified by the administrator to the present time/the whole area of the portion in the all sheets having been subjected to printing from the time specified by the administrator to the present time

Sheet-based area data (%)=the total dot area in the certain sized portion per sheet/the whole area of the portion

In this case, in the structure of FIG. 1, the first and second dot number counting sections 101 and 107 count only the number of dots formed on the certain sized portion, and the first and second pixel counting sections 102 and 108 count the number of pixels in the area. The total area data, the periodical area data, and the sheet-based area data are saved in a reference numbers 121a, 121b and 121c, respectively.

The first and second dot number counting sections 101 and 107 are arranged to count the number of dots formed on the sheet, based on the image data. More specifically, the first and second dot number counting sections 101 and 107 add up the all gradation values of the pixels in an image of image data. The addition result is regarded a number of dots in the image.

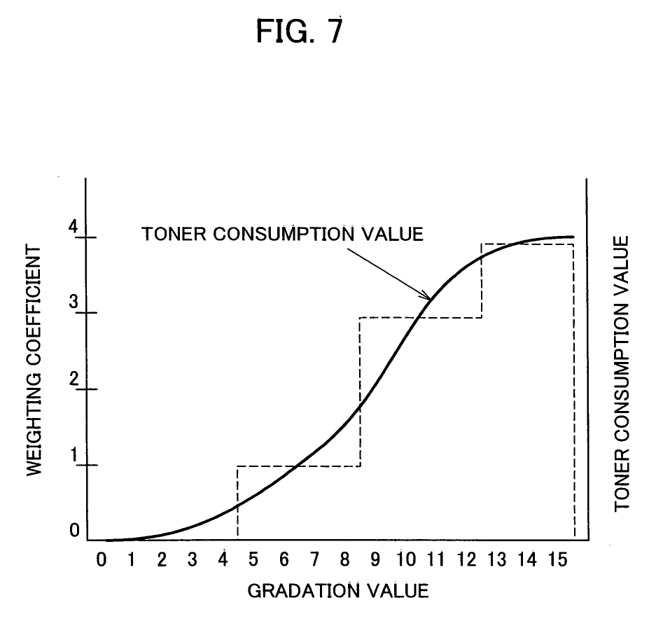

On the other hand, as shown in FIG. 7, a gradation value and a toner amount consumed by the gradation value have a positive relationship, but it is not a linear function relationship but a nonlinear. That is, the dot numbers counted by the first/second dot number counting sections 101/107 do not have a linear relationship with the actual toner consumption, and therefore the total dot number or the total coverage does not have a linear relationship with the actual toner consumption either. Considering this, it may be possible to predict the degree of toner consumption by the total dot number or the total coverage, but it is difficult to accurately measure the actual toner consumption.

In view of this problem, a weighting section is provided in a preceding stage of each of the first and second dot number counting sections 101 and 107. The weighting section weights the respective gradation values with predetermined different coefficients, and the respective pieces of weighted image data are inputted to the first and second dot number counting sections 101 and 107. For example, in the case of image data having 0-15 gradation levels, the weighting section weights the values according to a weighting coefficient table shown in FIG. 1.

TABLE 1

| | | WEIGHTING |
|---|---|---|
| | GRADATION VALUE | COEFFICIENT |
| AREA 1 | 0-4 | 0 |
| AREA 2 | 5-8 | 1 |
| AREA 3 | 9-12 | 3 |
| AREA 4 | 13-15 | 4 |

More specifically, the weighting section weights the respective gradation values by multiplying each value by a predetermined coefficient, so that the respective pieces of weighted image data are inputted to the first and second dot number counting sections 101 and 107. For example, according to Table 1, the weighting section converts the gradation value “9” into “27”, so that the first dot counting section figures out a gradation value of “27”.

As shown in FIG. 7, the gross of the weighted gradation values is expressed by the area of a portion surrounded by the broken line and the horizontal axis. Here, the toner consumption corresponding to the gross of the gradation values is expressed by the area of the portion surrounded by the thick line and the horizontal axis. The area of a portion surrounded by the broken line and the horizontal axis, and the area of the portion surrounded by the thick line and the horizontal axis are substantially matched.

The dot number counted by the first/second dot number counting section 101/107 based on the image weighted by the weighting section more accurately corresponds to the actual toner consumption, which also makes the total dot number or the total coverage to be closer to the actual toner consumption. Therefore, the toner consumption amount can be estimated more precisely.

Further, in the case where the user of MFP 1 inputs a user ID (identification) in carrying out a printing job, the coverage monitor 150 may separately record a periodic coverage for each user.

In this case, the periodic dot number storage area 120c has periodic dot numbers classified for each user, the periodic pixel number storage area 120d has periodic pixel numbers classified for each user, and the periodic coverage storage area 121b has periodic coverages classified for each user.

When a user inputs a user ID into the MFP 1 so as to carry out a printing job, the user ID is transmitted to the periodic dot number updating section 105 and the periodic pixel number updating section 106. Then, in response to execution of the printing job, the periodic dot number updating section 105 updates the periodic dot number of the user corresponding to the transmitted user ID in the periodic dot number storage area 120c. Further, the periodic pixel number updating section 106 updates the periodic pixel number of the user corresponding to the transmitted user ID in the periodic pixel number storage area 120d.

Then, receiving the updated periodic dot number and the updated periodic pixel number, the periodic coverage updating section 112 updates the periodical coverage in the periodical coverage storage area 121b based on the transmitted numbers. Here, the periodic coverage updating section 112 only updates the periodic coverage of the user corresponding to the transmitted user ID, leaving the others as such.

In this way, the periodical coverages are stored separately for each user of the MFP 1, allowing the administrator to comprehend the differences in toner consumption among plural users. Further, this also enables the administrator to set a different counter charge (charge per sheet) for each user. The printing price is thus calculated more equitably.

The following more specifically explains this arrangement. It is here assumed that the periodic coverages for the users A, B and C are 2.5%, 5% and 10%, respectively, and that a single toner box of the MFP 1 lasted for 15000 sheets when the coverage is 5%.

In this case, if each of the users A, B and C consumes 15000 sheets for printing per month, 0.5 toner box is required for the user A, 1 toner box is required for the user B, and 2 toner box is required for the user C. The profit of the administrator thus greatly relies on the usage condition of the user.

The profit can be more equally made if the administrator set different prices for each user, in consideration of their periodic coverages. For example, the administrator charges the user A, who consumes a small amount of toner, 8 yen per sheet, charges the user B 10 yen per sheet, and charges the user C, who consumes the largest amount of toner, 12 yen per sheet. In this way, the administrator sets different charges for each user in the image forming operation by the MFP 1. The price is thus calculated more equitably.

Further, as another possible arrangement, the coverage monitor may have a function of estimating exchanging timing of the toner box 7. According to the estimation, the coverage monitor 150 informs the administrator of necessity of exchange/preparation of toner box 7a. The following specifically explains this arrangement.

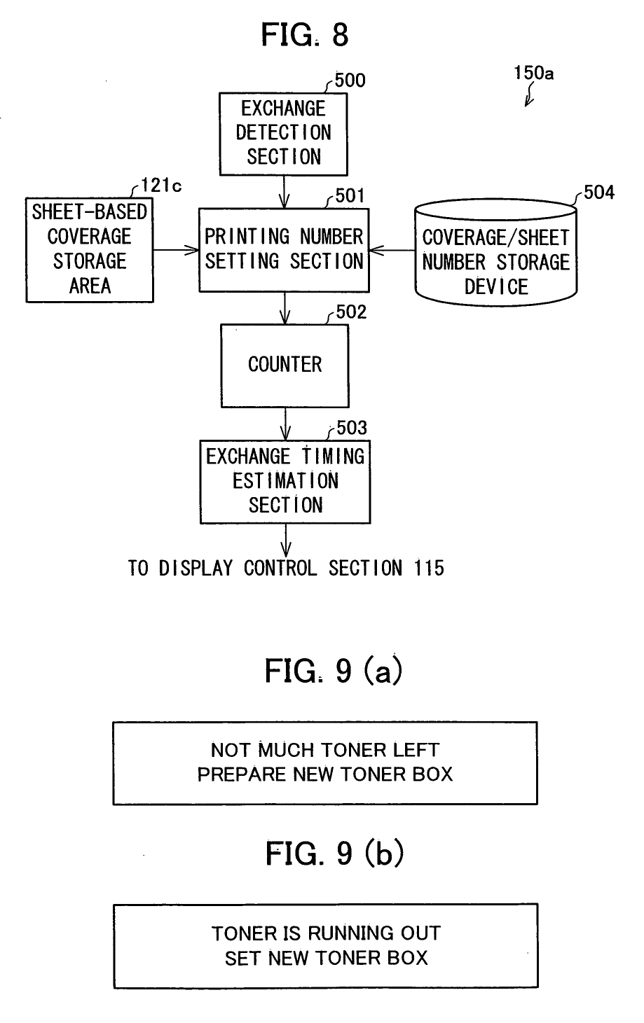

As shown in FIG. 8, the black toner coverage monitor 150a includes an exchange detection section 500, a printing number setting section 501, a counter 502, an exchange timing estimation section 503, and a coverage/sheet number storage device 504. Note that, tough they are omitted in the figure, the structure of FIG. 8 also includes the respective sections and storage devices shown in FIG. 1.

The coverage/sheet number storage device 504 is a storage device for storing a table showing a correlation between the coverage value of the MFP 1 and the number of printings which the MFP is capable in a period that a new (full) toner box 7a is completely consumed. For example, a coverage of 3% corresponds to 10000 times printings (10000 sheets). This means that the MFP 1 is capable of printing 10000 sheets with a full toner box 7a if the printing is carried out under a coverage of 3%.

The coverage/sheet number storage device 504 stores a correlation with the number of printings for each coverage value.

The exchange detection section 500 is a block for detecting exchange of toner box 7a and transmitting the completion of exchange to the printing number setting section 501.

Receiving the notice of completion of exchange from the exchange detection section 500, the printing number setting section 501 estimates the number of printings which the MFP 1 is capable in a period that a new toner box 7a with a full amount of toner becomes empty, and sets the counter 502 with the estimation result. More specifically, the printing number setting section 501 reads out a corresponding sheet-based coverage from the sheet-based coverage storage area 121c (see FIG. 1), and finds a printing number associated with the value of the sheet-based coverage in the coverage/sheet number storage device 504. The printing number setting section 501 reads out the printing number and sets the counter with the number.

In other words, the printing number setting section 501 estimates the number of printings which the MFP 1 is capable with a single toner box 7a, with an assumption that the printing operation will carry on under the same sheet-based coverage which was measured in one of the actual operations.

Note that, the printing number setting section 501 estimates the number of printings with reference to the coverage/sheet number storage device 504 in the foregoing example; however, the printing number setting section 501 may otherwise figure out the number of printings by a predetermined calculation using the sheet-based coverage.

The counter 502 is a block for counting the number of sheets in each printing job performed by the MFP 1, and subtracting the number form the printing number set in the counter 502.

When the printing number set in the counter 502 falls below a first threshold, the exchange timing estimation section (exchange timing estimation section 503) determines that the toner box 7a soon needs to be replaced, and transmits a first display command, which is an instruction for displaying a first message image to the display control section 115. Further, when the printing number set in the counter 502 falls below a second threshold smaller than the first threshold, the exchange timing estimation section 503 determines that the toner box 7a is almost empty, and transmits a second display command, which is an instruction for displaying a second message image to the display control section 115.

Here, as shown in FIG. 9(a), the first message image is an image for requesting preparation of a new toner box 7a. Further, as shown in FIG. 9(b), the second message image is an image for requesting exchange of the existing toner box 7a with a new toner box 7a, as the toner almost ran out.

The exchange timing estimation section 503 displays the first message image in the display device 300 in response to receipt of the first display command from the exchange timing estimation section 503, and displays the second message image in the display device 300 in response to receipt of the second display command from the exchange timing estimation section 503.

With this arrangement, the exchange timing estimation section 503 previously estimates the number of printings (number of sheets) which the MFP 1 is capable with a single toner box 7a, based on the sheet-based coverage (amount of toner consumed by a sheet in the MFP 1), which is measured in an actual operation. Therefore, the notification of preparation of toner or of exchange of toner may be carries out plenty before the toner is completely consumed.

On the other hand, in a conventional method for detecting exchange timing by using an ATC, the user is not informed of the fact that the toner box soon needs to be exchanged until the very last moment, i.e. when the toner box becomes almost empty. That is, there was no way to previously inform the administrator of the exchange timing of the toner box 7a. Because of this the stock management of toner was not easy.

The function of the coverage monitor 150 according to the present embodiment may be realized by executing a program, which is stored in a storage section (eg. ROM, RAM etc.) by a calculation circuit such as a processor, and controlling the various peripheral circuits, sensors etc. That is, the various functions/operations of the coverage monitor 150 may be realized by reading out the program from the storage medium by the computer having the calculation circuits, peripheral circuits etc. and executing the program by the computer. Further, by storing the program into a removable storage medium, the various functions and operations may be performed on an arbitrary computer.

Examples of the program medium include (a) a tape system such as a magnetic tape, a cassette tape or the like, (b) a disk system which includes a magnetic disk such as a floppy disk®, a hard disk or the like and an optical disk such as a CD-ROM, an MO, an MD, a DVD, CD-R or the like, (c) a card system such as an IC card (inclusive of a memory card), an optical card or the like, and (d) a semiconductor memory such as a mask ROM, an EPROM, an EEPROM, a flash ROM.

Further, the coverage monitor 150 may be constituted to be connectable to a communication network, so as to allow provision of the program code via a communication network. The communication network is not particularly limited, and it may be: the Internet, Intranet, Extranet, LAN, ISDN, VAN, CATV communication network, virtual private network, telecommunication network, mobile body communication network, satellite communication network etc. Further, a transmission medium for constituting the communication network is not particularly limited, and it may be wired based, such as IEEE1394, USB, power-line carrier, cable TV line, telephone line, ADSL line, or radio based, such as infrared medium such as IrDA, remote control, Bluetooth®, 802.11 radio, HDR, mobile phone network, satellite communication line, ground wave digital network. Note that, the present invention may be realized in the form of a carrier wave, or a data signal line that realize the program code by electronic transmission.

Note that, the coverage monitor 150 is suitable for any image forming device which forms an image on a sheet with toner. Examples of image forming device includes a laser printer, a photocopier, a multifunctional device, and an inkjet printer.

The present invention is not limited to the description of the embodiments above, but may be altered by a skilled person within the scope of the claims. An embodiment based on a proper combination of technical means disclosed in different embodiments is encompassed in the technical scope of the present invention.

Further, the monitoring device according to the present embodiment may further comprise a total consumption scale data generating section for generating total consumption scale data which denotes a scale of total toner consumption of the image forming device, based on the image data. In this case, the transmission section transmits the total consumption scale data to the administrator.

This arrangement allows the administrator to comprehend the respective total toner consumption amounts of all image forming devices under the administrator's charge, which means that the administrator can comprehend the degree of toner consumption in the whole market. Therefore the stock management of toner, planning of manufacturing toner etc. become easy (e.g. the administrator more easily estimates the required number of toner bottles).

Further, the administrator may refer to the information of total toner consumption amount in developing a new image forming device. The information of total toner consumption is useful to create an image forming device meeting real demands in the market.

The monitoring device according to the present embodiment may further comprises a sheet-based consumption scale data generating section for generating sheet-based consumption scale data which denotes a scale of toner consumption in the case of carrying out image forming with respect to a predetermined number of sheets, based on the image data. In this case, the transmission section transmits the sheet-based consumption scale data to the administrator.

With this arrangement, in addition to the total toner consumption and the toner consumption in a certain period, the administrator can also comprehend toner consumption per sheet (or for a predetermined number of sheets). The administrator can thus easily estimate a toner amount required for a single sheet.

The monitoring device according to the present embodiment may further comprises an exchange timing estimating section for estimating an exchanging timing of a toner cartridge of the image forming device, based on the sheet-based consumption scale data. In this case, the transmission section transmits the exchange timing to the administrator.

With this arrangement, the exchange timing estimating section estimates the toner exchange timing according to the sheet-based consumption scale data, and informs the administrator of the exchange timing. This allows the administrator to estimate an exchange timing of a toner cartridge, and thereby the administrator exchanges toner cartridge before the image forming device completely consumes the toner.

The transmission section may serve as a display control section for displaying in the display device an image showing the exchange timing. The transmission section may serve as a display control section for displaying in the display device an image for requesting preparation of a new toner cartridge at the exchange timing. The transmission section may serve as a display control section for displaying in the display device an image for requesting exchange of toner cartridge at the exchange timing.

In the monitoring device according to the present embodiment, the toner consumption scale may be expressed as a coverage which designates a ratio of printing area in a single sheet to an area of dots formed in the printing area. Further, the toner consumption scale may be a dot count value which designates a number of dots formed on a sheet.

In addition to the foregoing arrangement, the monitoring device according to the present embodiment may be arranged such that the transmission section serves as a communication section which transmits data to the administrator by sending data to a terminal device of the administrator via a public network.

This structure allows the administrator to monitor the total coverage, the periodic coverage, and the sheet-based coverage of the image forming device with his own terminal device.

The image forming device may be provided with a toner cartridge which is detachable to the image forming device, the toner cartridge having a storage device for storing data. The monitoring device may further comprises a dot count value writing section which writes into the storage device of the toner cartridge a dot count value which indicates a number of dots having been formed on sheets since the toner cartridge is mounted to the image forming device, based on the image data.

With this function, the total dot number is counted in the whole time where the toner box is mounted to the image forming device, and the counted value is stored in the storage device of the toner cartridge. This allows the administrator to compare the dot number stored in the storage device of the toner cartridge and the actual toner content of the cartridge after the administrator collects an empty toner cartridge for replacement. With this comparison the administrator can check reliability of the dot number as a factor of actual toner consumption amount.

The monitoring device according to the present embodiment may further comprise a weighting section for weighting various gradation values of the image data with plural predetermined coefficients respectively corresponding to the gradation values.

A gradation value and a toner amount consumed by the gradation value have a positive relationship, but it is not a linear function relationship but a nonlinear. In view of this, the foregoing structure weights the image data by the weighting section so that the toner consumption scale data more accurately corresponds to the actual toner consumption. Consequently, the total dot number, the total coverage etc. also become closer to the actual toner consumption as they are generated by the weighted image data. Therefore, the toner consumption amount can be estimated more precisely.

In addition to the foregoing arrangement, the monitoring device according to the present embodiment may be arranged such that the transmission section transmits data only to a user who has inputted an administration ID which proves that the user is an administrator.

The data showing toner consumption scale should be confidential as it relates to the profit rate or the accounting. In view of this, the foregoing arrangement ensures that only a proper administrator is notified of the total coverage, the periodic coverage, and the sheet-based coverage, avoiding these data items to be revealed to unknowns.

Note that, the foregoing monitoring device may be realized by a computer. In this case, the scope of the present invention includes a program for causing a computer to function as the respective sections of the monitoring device, and a computer-readable storage medium storing the program.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A monitoring device for monitoring a utilization scale of an image forming device which forms an image on a sheet with toner,
the monitoring device comprising:
a periodic consumption scale data generating section for generating periodic consumption scale data which denotes a toner consumption scale from a certain time point, which is specified by an administrator of the image forming device, to a present time, based on image data expressing the image; and
a transmission section for transmitting the periodic consumption scale data to the administrator.

2. The monitoring device as set forth in claim 1, further comprising:
a total consumption scale data generating section for generating total consumption scale data which denotes a scale of total toner consumption of the image forming device, based on the image data,
wherein:
the transmission section transmits the total consumption scale data to the administrator.

3. The monitoring device as set forth in claim 1, further comprising:
a sheet-based consumption scale data generating section for generating sheet-based consumption scale data which denotes a scale of toner consumption in the case of carrying out image forming with respect to a predetermined number of sheets, based on the image data,
wherein:
the transmission section transmits the sheet-based consumption scale data to the administrator.

4. The monitoring device as set forth in claim 2, further comprising:
a sheet-based consumption scale data generating section for generating sheet-based consumption scale data which denotes a scale of toner consumption in the case of carrying out image forming with respect to a predetermined number of sheets, based on the image data,
wherein:
the transmission section transmits the sheet-based consumption scale data to the administrator.

5. The monitoring device as set forth in claim 3, further comprising:
an exchange timing estimating section for estimating an exchanging timing of a toner cartridge of the image forming device, based on the sheet-based consumption scale data,
wherein:
the transmission section transmits the exchange timing to the administrator.

6. The monitoring device as set forth in claim 4, further comprising:
an exchange timing estimating section for estimating an exchanging timing of a toner cartridge of the image forming device, based on the sheet-based consumption scale data,
wherein:
the transmission section transmits the exchange timing to the administrator.

7. The monitoring device as set forth in claim 5, wherein:
the transmission section serves as a display control section for displaying in the display device an image showing the exchange timing.

8. The monitoring device as set forth in claim 5, wherein:
the transmission section serves as a display control section for displaying in the display device an image for requesting preparation of a new toner cartridge at the exchange timing.

9. The monitoring device as set forth in claim 5, wherein:
the transmission section serves as a display control section for displaying in the display device an image for requesting exchange of toner cartridge at the exchange timing.

10. The monitoring device as set forth in claim 1, wherein:
the toner consumption scale is expressed as a coverage which designates a ratio of printing area in a single sheet to an area of dots formed in the printing area.

11. The monitoring device as set forth in claim 1, wherein:
the toner consumption scale is a dot count value which designates a number of dots formed on a sheet.

12. The monitoring device as set forth in claim 1, wherein:
the transmission section serves as a communication section which transmits data to the administrator by sending data to a terminal device of the administrator via a public network.

13. The monitoring device as set forth in claim 1, wherein:
the image forming device is provided with a toner cartridge which is detachable to the image forming device, the toner cartridge having a storage device for storing data,
the monitoring device further comprising a dot count value writing section which writes into the storage device of the toner cartridge a dot count value which indicates a number of dots having been formed on sheets since the toner cartridge is mounted to the image forming device, based on the image data.

14. The monitoring device as set forth in claim 1, further comprising:
a weighting section for weighting various gradation values of the image data with plural predetermined coefficients respectively corresponding to the gradation values.

15. The monitoring device as set forth in claim 2, further comprising:
a weighting section for weighting various gradation values of the image data with plural predetermined coefficients respectively corresponding to the gradation values.

16. The monitoring device as set forth in claim 3, further comprising:
a weighting section for weighting various gradation values of the image data with plural predetermined coefficients respectively corresponding to the gradation values.

17. A monitoring device as set forth in claim 1, wherein the transmission section transmits data only to a user who has inputted an administration ID which proves that the user is an administrator.

18. A method for controlling a monitoring device for monitoring a utilization scale of an image forming device which forms an image on a sheet with toner,
the method comprising the steps of:
(i) generating periodic consumption scale data which denotes a scale of toner consumption from a certain time point, which is specified by an administrator of the image forming device, to a present time, based on image data expressing the image; and
(ii) transmitting the periodic consumption scale data to the administrator.

19. A program for controlling operation of a monitoring device for monitoring a utilization scale of an image forming device which forms an image on a sheet with toner,
the program causing a computer to function as:
(i) a periodic consumption scale data generating section for generating periodic consumption scale data which denotes a toner consumption scale from a certain time point, which is specified by an administrator of the image forming device, to a present time, based on image data expressing the image; and
(ii) a transmission section for transmitting the periodic consumption scale data to the administrator.

20. A computer-readable storage medium storing a program for controlling operation of a monitoring device for monitoring a utilization scale of an image forming device which forms an image on a sheet with toner,
the program causing a computer to function as:
(i) a periodic consumption scale data generating section for generating periodic consumption scale data which denotes a scale of toner consumption from a time point, which is specified by an administrator of the image forming device, to a present time, based on image data expressing the image; and
(ii) a transmission section for transmitting the periodic consumption scale data to the administrator.
